(19) United States
(12) Patent Application Publication
(10) Pub. No.: US 2021/0303315 A1
(43) Pub. Date: Sep. 30, 2021

(54) APPLICATION LOGIC ARCHITECTURE DEFINING SEPARATE PROCESSING PLANES

(71) Applicant: SRC Labs, LLC, Dallas, TX (US)

(72) Inventors: Todd Rooke, Colorado Springs, CO (US); Jon Huppenthal, Colorado Springs, CO (US); Timothy P. Wilkinson, Apalachin, NY (US)

(21) Appl. No.: 17/218,128

(22) Filed: Mar. 30, 2021

Related U.S. Application Data
(60) Provisional application No. 63/002,476, filed on Mar. 31, 2020.

(51) Int. Cl. G06F 9/445; G06F 13/40

(52) U.S. Cl. CPC G06F 9/44505; G06F 13/4027

(57) ABSTRACT

A system includes an application plane having a reconfigurable logic device defining application logic, a data input plane defining a first port operable to receive application data for processing on the application logic and a management plane defining a second port separate from the first port and operable to reconfigure the application logic

### BACKGROUND

In a traditional instruction processor based system, both inbound data and processor instructions can arrive on the same physical port. This architecture opens the door for a user who is supposed to be providing data to an application to instead actually cause the processor to execute unintended functions. Computer systems are commonly attacked using this vulnerability. Obtaining physical access to this port allows bad actors to cause processors within the system to perform nefarious activities on a system. As a result, instruction processor based systems incorporate software based security to restrict access. However, this software is only secure until the next new attack, typically referred to as a “Zero Day” attack.

### SUMMARY

A system includes an application plane having a reconfigurable logic device defining application logic, a data input plane defining a first port operable to receive application data for processing on the application logic and a management plane defining a second port separate from the first port and operable to reconfigure the application logic. The data input plane is prevented from altering the application logic and the management plane is prevented from altering memory associated with the application logic.

### BRIEF DESCRIPTION OF THE DRAWINGS

FIG. 1 is a schematic diagram of a multi-processor system.

FIG. 2 is a schematic diagram of an architecture implementation for the multi-processor system of FIG. 1 implemented within a chassis.

### DESCRIPTION

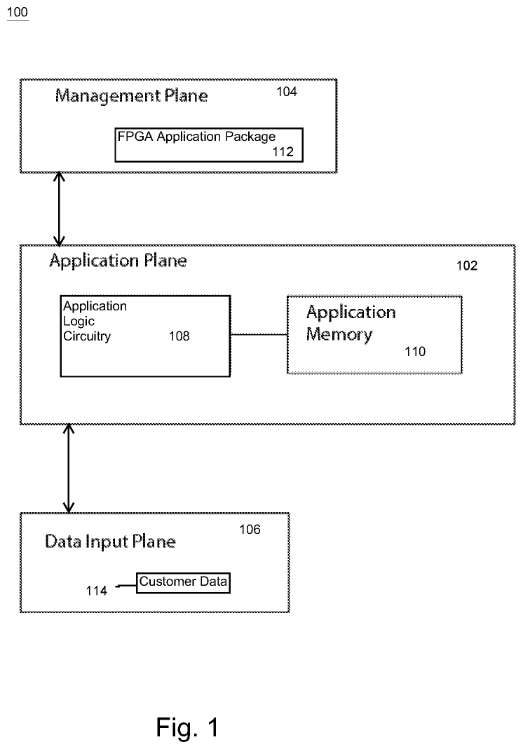

FIG. 1 is a schematic diagram of a multi-processor system 100 employing an application plane 102, a management plane 104 and a data input plane 106. The application plane 102 is configured to operate a data processing application and includes application logic circuitry 108 and application memory 110. Management plane 104 is configured to provide application packages 112 to the application plane 102 for deployment onto the application logic circuitry 108. During operation of the application logic circuitry 108, the data input plane 106 provides application data 114 (in this example, customer data 114) to the application plane 102 for processing by the application logic circuitry 108. Application logic circuitry 108 can utilize application memory 110 in the processing of application data 114 received from the data input plane 106.

In one embodiment, when ready for deployment, management plane 104 accesses application package 112, including one or more bitstreams and stream connection information specifying connection between streams when the application package 112 is deployed on application logic circuitry 108. The application package 112 can be protected and encrypted in order to generate a secure deployment. Management plane 104 uses the application package 112 to communicate with the application plane 102 so as to deploy the application package 102 on the application logic circuitry 108. In one embodiment the management plane 104 can utilize one or more management FPGAs to communicate with and deploy the application package 112.

As used herein, application package 112, when deployed onto application logic circuitry 108, includes any computer program that performs data processing where most or all of the data processing is performed on reconfigurable hardware such as an FPGA processor. In one embodiment, the run-time environment is entirely FPGA based without an operating system utilizing a mix of reconfigurable compute nodes, reconfigurable switches, reconfigurable common memory nodes, and reconfigurable I/O nodes. In another embodiment, in a run-time environment, the application package 112 can be deployed to utilize a mix of microprocessors, with an operating system or compiled as machine code without an operating system, reconfigurable compute nodes, reconfigurable common memory accessible by the processors and switch modules in various combinations as specified. Other elements can be used in the application package 112, such as stream protocols, stream data sources, I/O connectors (providing connection along an internal wire), I/O agents (providing connection to an external system, components of code blocks and composite components formed of multiple components of code blocks.

In some embodiments, the application logic circuitry 108 includes one or more ingress points (portions of application logic that receive input messages external to the application logic circuitry 108), one or more egress points (portions of application logic that communicate output messages externally from the application logic circuitry 108), one or more reconfigurable compute nodes (e.g., physical FPGA's that process data), one or more memory nodes (e.g., including application memory 110, persistent physical memory, non-persistent physical memory) accessible to the processing nodes whereby the processing nodes read and write data to the memory nodes and one or more switches including executable logic for routing and communicating among the processing and memory nodes. In some embodiments, the compute nodes can include microprocessors.

Management plane 104 can use a cryptography engine and a deployment protocol manager in securely transmitting the application package 112 to the application plane 102. The cryptography engine can encrypt the application package 112 such that the encrypted file can be sent to application plane 102 for deployment. In combination, the deployment protocol manager can manage keys and other secure elements to ensure that the application package 112 encrypted by the cryptography engine remains secure and only deployed to application logic circuitry 108.

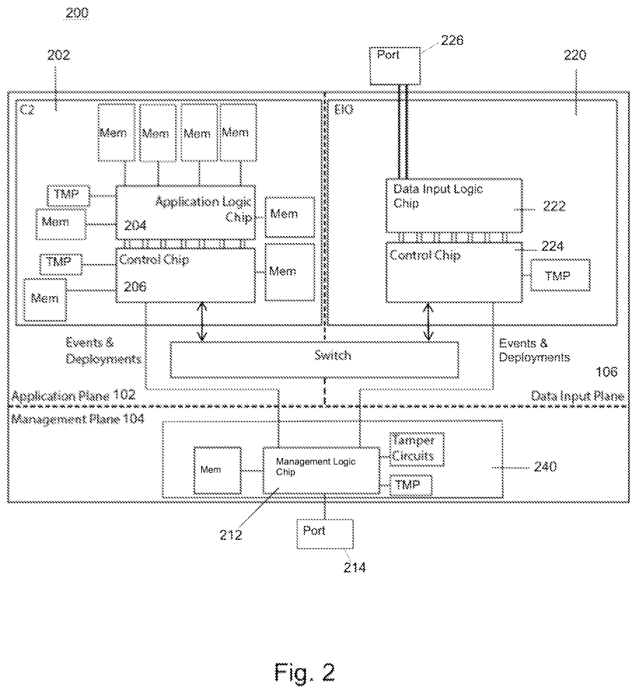

FIG. 2 is a schematic representation of an example implementation of a multi-processor system 200 implementing the application plane 102, management plane 104 and data input plane 106. The application plane 102 is implemented on a printed circuit board (PCB) 202, which carries an application logic chip 204 and a control chip 206. Each of the application logic chip 204 and control chip 206 can be associated with a trusted platform module and/or memory modules as desired. The management plane 104 can be implemented on a PCB 210 that includes a management logic chip 212. The management logic chip 212 can be associated with a trusted platform module, a tamper circuit and/or memory modules as desired. Connected with the management logic chip 212 is a communication port 214 (e.g., SFP, SFP+, QSFP) that serves as a communication interface between an external system and the management plane 104. The data input plane 106 is implemented on a PCB 220, which carries a data input logic chip 222 and a control chip 224. In one embodiment, the control chip 224 is associated with a trusted platform module as desired. Connected with the data input logic chip 222 is a communication port 226 (e.g., SFP, SFP+, QSFP) that serves as a communication interface between an external system and the data input plane 106.

Within system 200, the management plane 104 is responsible for deploying an updating logic onto the application logic chip 204. The data input plane 106 is responsible for sending and receiving data that is processed by the application logic chip 204. Conceptually and electrically, the management plane 104 and data input plane 106 are separated such that data on the input plane 106 is not used to modify logic on the application logic chip 204 and management plane 104 is not used to modify application data sent into or out of the application logic chip 204. For example, a first bus (or bus network) directly connects port 226 through the data input plane 106 to the control chip 206 (via a shared switch) and a second bus (or bus network) directly connects port 214 through management plane 104 to control chip 206. The first bus and second bus are separate and communication between the respective buses is prevented.

In one embodiment, each of the chips 204, 206, 212, 222 and 224 are reconfigurable logic circuits that are not traditional instruction processors. In conventional instructional processors, input data as well as processor instructions can arrive on the same physical port. This situation allows a bad actor to provide nefarious processor instructions where an application is expecting data for processing by the application. Additionally, a bad actor administrator also has the ability to snoop or redirect user data for unintended purposes.

Within system 200, application logic is deployed to any of the chips 204, 206, 212, 222 and 224 such that the chips only perform that function of the deployed application logic. As a result, data arriving on the data input plane 106 has no physical connectivity to change functionality of the application logic. The application logic can only be altered by pre-verified encrypted application logic being sent to management logic chip 212. The management logic chip 212 in turn communicates to control chip 206. The control chip 206 then deploys application logic onto the application logic chip 204. This process eliminates any possibility of user data from the input plane 106 altering application logic on the application logic chip 204. Rather, instructions to alter application logic received on the data input plane 106 can be ignored or otherwise not useful in changing application logic on the application logic chip. In a similar manner, data requests to memory associated with the application logic chip 204 received from the management logic chip 212 can be ignored or otherwise not useful in gaining access to memory associated with the application logic chip 204.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A system, comprising:
an application plane having a reconfigurable logic device defining application logic;
a data input plane defining a first port operable to receive application data for processing on the application logic; and
a management plane defining a second port separate from the first port and operable to reconfigure the application logic.

2. The system of claim 1, wherein the management plane includes a management circuit operably coupled with the application plane so as to provide updated application logic to be deployed on the reconfigurable logic device.

3. The system of claim 2, wherein the data plane further includes a network interface circuit operably coupled with the application plane so as to provide the application data to the application logic.

4. The system of claim 3, wherein the application plane further includes a control circuit operably coupled with the reconfigurable logic device, the management circuit and the network interface circuit, the control circuit operable to load updated application logic onto the reconfigurable logic device and transmit application data to the application logic.

5. The system of claim 4, further comprising:
a first bus coupling the management circuit to the control circuit; and
a second bus, separate from the first bus, coupling the network interface circuit to the control circuit.

6. The system of claim 2 wherein the management circuit comprises a cryptography engine to encrypt the updated application logic prior to transmission to the application plane.

7. The system of claim 6 wherein the management circuit further comprises a deployment protocol manager which cooperates with the cryptography engine to manage at least one cryptography key.

8. The system of claim 7 wherein the management plane is separated from the data input plane and configured such that data received on the data input plane is not capable of being used to modify the application logic.

9. The system of claim 8 further comprising a switch operably coupled between the data input plane and the application plane, the switch configured to allow the data to be transmitted between the data input plane and the application plane.

10. The system of claim 9 wherein the data input plane is housed upon a first printed circuit board and the application plane is housed on a second printed circuit board.

11. The system of claim 9 wherein the application plane further comprises an application plane control circuit and wherein the data plane further comprises a data plane control circuit, and wherein the application plane control circuit and the data plane control circuit are both operably coupled to the switch.

12. A reconfigurable application processing system, comprising:
an application plane having a reconfigurable logic device configured to operate a data processing application;
a data input plane operably coupled to a first port and configured to receive application data, transfer the data to the application plane for processing, receive processed data from the application plane and output processed data via the first port; and
a management plane operably coupled to a second port separate from the first port and configured to receive configuration data capable of reconfiguring the reconfigurable logic device thereby reconfiguring the data processing application, wherein the data input plane and the management plane are isolated from one another.

13. The reconfigurable application processing system of claim 12 wherein the management plane includes a management circuit operably coupled with the application plane and configured to provide updated application logic to be deployed on the reconfigurable logic device, and wherein the management circuit is further operably coupled to the data plane and configured to configured to coordinate the flow of data.

14. The reconfigurable application processing system of claim 13 wherein the data plane further includes a network interface circuit operably coupled with the application plane and configured to provide the application data to the application logic.

15. The reconfigurable application processing system of claim 12 further comprising a switch operably coupled between the data input plane and the application plane, the switch configured to allow the data to be transmitted between the data input plane and the application plane, wherein the switch is not connected to the management plane.

16. The reconfigurable application processing system of claim 15 wherein the wherein the management plane includes a management circuit operably coupled with the application plane and configured to provide updated application logic to be deployed on the reconfigurable logic device, and wherein the management circuit is further operably coupled to the data plane and configured to configured to coordinate the flow of data.

17. The reconfigurable application processing system of claim 16 wherein the management circuit comprises a cryptography engine to encrypt the updated application logic prior to transmission to the application plane.

18. The reconfigurable application processing system of claim 17 wherein the application layer further comprises an application control chip operably coupled to the management circuit and the application logic device, the application control chip configured to receive the updated application logic and deploy the updated application logic on the application logic device, and wherein the data plane comprises a data control chip and data input logic chip, with the data control chip coupled to the management circuit to receive information capable of configuring the data input logic chip.

19. The reconfigurable application processing system of claim 18 wherein the application logic device, the application control circuit, the data control chip and the data logic chip are reconfigurable logic circuits and are configured to receive instructions from the management circuit thereby allowing for reconfiguration thereof.
